(19) United States
(12) Patent Application Publication
(10) Pub. No.: US 2010/0323555 A1
(43) Pub. Date: Dec. 23, 2010

(54) Meter Collar

(75) Inventors: Franklin Christiaan Geiger, North Vancouver (CA); Harold David Hankel, Coquitlam (CA); Keith Richard Martin, Burnaby (CA); Mohammad Tootoonian Mashad, Vancouver (CA)

Correspondence Address: TANTALUS SYSTEMS CORP., #301 - 3480 GILMORE WAY, BURNABY - BRITISH COLUMBIA, V5G 4Y1, CA

(73) Assignee: Tantalus System Corp.

(21) Appl. No.: 12/457,828

(22) Filed: Jun. 23, 2009

(51) Int. Cl. H01R 33/945

(52) U.S. Cl. 439/517

(57) ABSTRACT

A meter adapter in the form of a collar interposed between meter and associated socket, provides a smooth curved jaw configuration for meter terminal blades, and branch fuse safety features.

### FIELD OF THE INVENTION

This invention relates to adapters to meters that, among other capabilities, measure common resources, especially electrical energy.

### BACKGROUND OF THE INVENTION

There are meters that, among other capabilities, measure common resources (herein, meant to include consumption of commodities like electrical energy, water, and gas). Standard meters, as understood in the electrical utilities business in the United States, Canada and herein, are those that conform to ANSI standard C12.10. This standard and others (and counterparts in jurisdictions around .the world) dictate a host of restrictions, including the physical envelope or form factor, the dimensions, locations and materials for power pins, the permissible types of electrical connections with the meter, and similar items, for a one or multi-phase electricity measuring meter. These standards try to maximize safety and inter-compatibility of meters from different manufacturers. This ANSI standard in effect, prohibits or strongly discourages any electrical connection between the meter and anything else except for the power pins and grounds.

To make a standard meter a useful part of a network, it is desirable to provide it with extra functionality and ideally, to so provide by means of an easily releasably attachable adapter, and in particular herein, a collar with superior (mechanical and electrical) interconnection and safety (e.g. fuse) capabilities. It is also desirable to minimize the overall physical “footprint” of the collar (while still conforming to safety standards) and yet be large enough to house the desired extra functionality. The present invention addresses those objectives. And although the embodiment of the present invention described below is with reference to a standard electrical meter, certain aspects of it are not thereby restricted thereto, and are applicable to meters that measure other resources (such as water and gas).

The current art has complexities and associated disadvantages. Typical is U.S. Pat. No. 5,762,522 that shows a fuse and mechanical contact clip which is complex (in requiring a plurality of parts, including rivets and several angled portions). The present invention addresses the complexities with a simpler approach.

For a metered premise (house or commercial/industrial venue), the branch circuits and associated safety management (e.g. fuses) are conventionally on the load side of the meter (i.e. the part of the meter that is associated with the load side terminals, and which the utility uses to measure consumption or other attribute of electricity by the load side circuit, and is governed by a utilities regulatory regime, as distinct from a safety standards regime). Thus, for example, fuse/circuit breaker panels (and associated branch circuits to various in-house loads) are found typically inside the house and are (at least) electrically downstream from the line side of the meter, i.e. they tap the load side terminals.

For evolving applications and needs (e.g. for “smart grid” meters, as exemplified in U.S. Pat. No. 7,019,666), there are advantages to create and supply “branch circuits” on the line side of the meter (i.e. the part of the meter that is associated with the line side terminals, and that is not measured by the utility for consumption of electricity, and is governed by a safety and related regulatory regime (like the National Electric Code or equivalent), as distinct from a utilities regulatory regime).

Previous attempts (for examples, U.S. Pat. Nos. 7,182,632 and 7,040,920) promised added functionality to the meter collar using the line side of the meter without address the consequent issues. For such extra functionality, the present invention addresses such issues, including those related to safety.

### SUMMARY OF THE INVENTION

There is provided a collar adapter for a utility meter and its associated meter socket, which has terminals for the line side and terminals for the load side, comprising: (a) a first power pin for receiving first terminal blade of the meter; (b) said first power pin is connectable to first line side terminal of the meter socket; (c) a first branch fuse, attached to said line side power pin, that is in electrical parallel relationship thereto and that runs to a branch load circuit.

There is also provided a collar adapter for a utility meter and its associated meter socket, which has terminals for the line side and terminals for the load side, comprising: (a) a power pin that has two opposed jaws for receiving one terminal blade of the meter; and (b) a C-shaped ring spring that biases said jaws towards each other.

Within the physical frame of a meter collar, the present invention provides the operator of the meter (for example, the utility) the opportunity to conveniently and safely use the line side terminals to power new functionality of a branch load. Because the use is located within the collar, advantages and conveniences are provided, including the fact that the customer will not be billed for any use of electricity for that new functionality. Although current safety regulations are not yet formalized on the line side, the present invention satisfies load side regulations as if notionally transposed to the line side.

### BRIEF DESCRIPTION OF THE DRAWINGS

A better understanding of the present invention can be obtained when the following detailed description of the preferred embodiment is considered in conjunction with the following drawings, in which:

FIG. 1 is a perspective view of the collar in relationship with the meter and meter socket;

FIG. 2 is a detailed perspective view of the collar;

FIG. 3 is a partially broken back perspective view of the branch fuse in the collar;

FIG. 4 is a partially broken front perspective view of the branch fuse in the collar;

FIG. 5 is a back perspective view of the power pin and branch fuse;

FIG. 6 is a more detailed side of the jaw portion of FIG. 5;

FIG. 7 is a perspective view of the ring spring;

FIG. 8 is a diagram of the forces on the jaw finger on installation; and

FIG. 9 is a graph of a model curve for the jaw finger.

### DETAILED DESCRIPTION OF THE PREFERRED EMBODIMENT

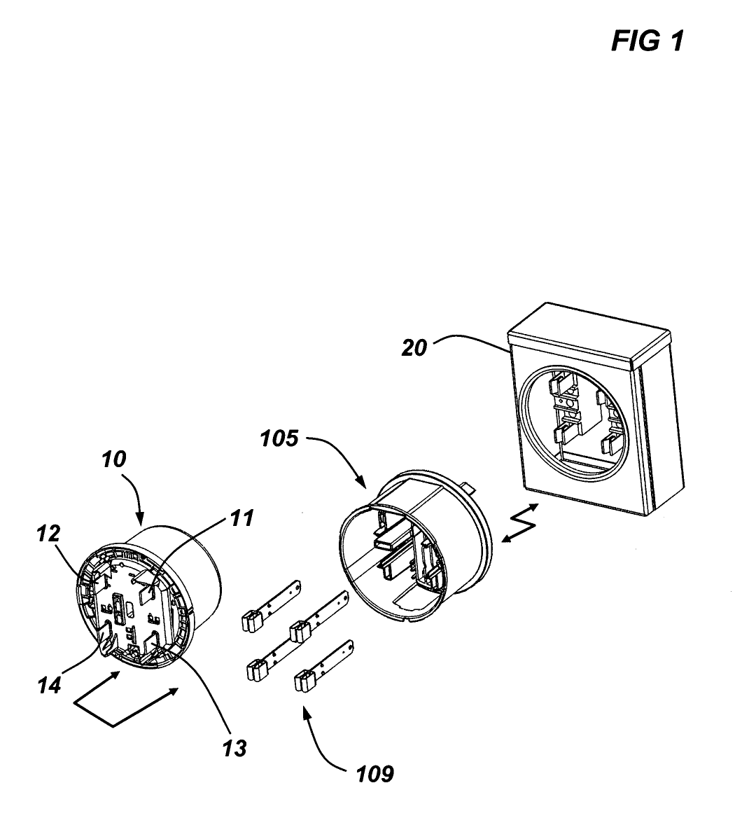

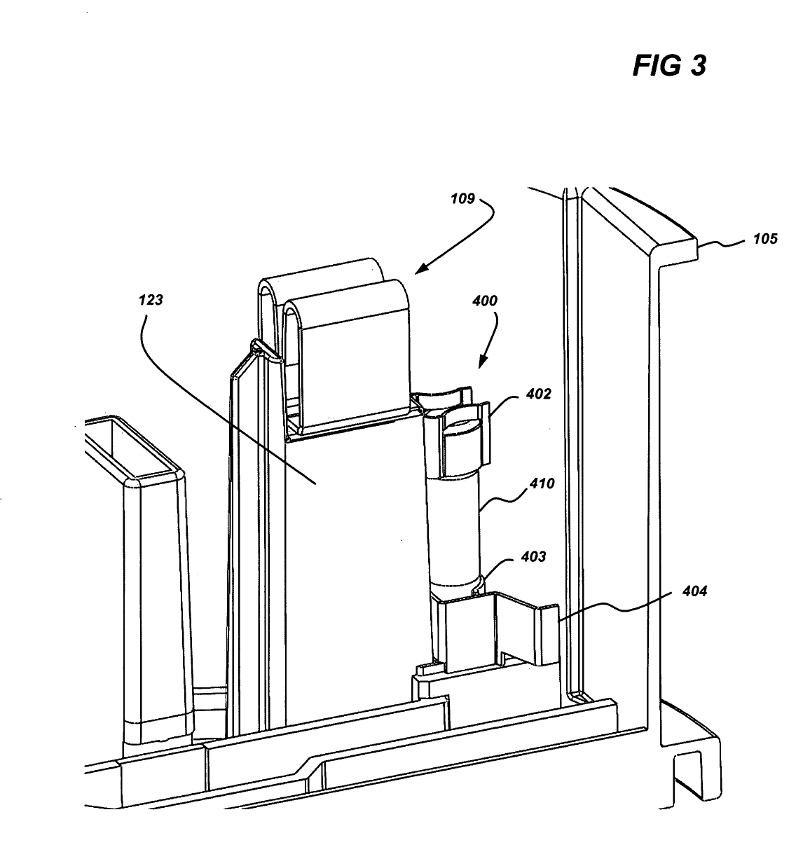

As shown in FIGS. 1-5, collar 105 is interposed (mechanically and electrically) between utility meter 10 and its associated meter socket 20.

The mechanical interposition is achieved partially by conventional mechanisms (including fastening mechanisms and mating of respective perimeter profiles and mounting surfaces) and partially by improved mechanisms (described below). The electrical agency between meter 10 and meter socket 20 is provided by the use of four identical power pins 109, snugly fitted into collar mounting slots 121 and 122 (for the meter load line terminals) and into collar mounting slots 123 and 124 (for the meter line side terminals).

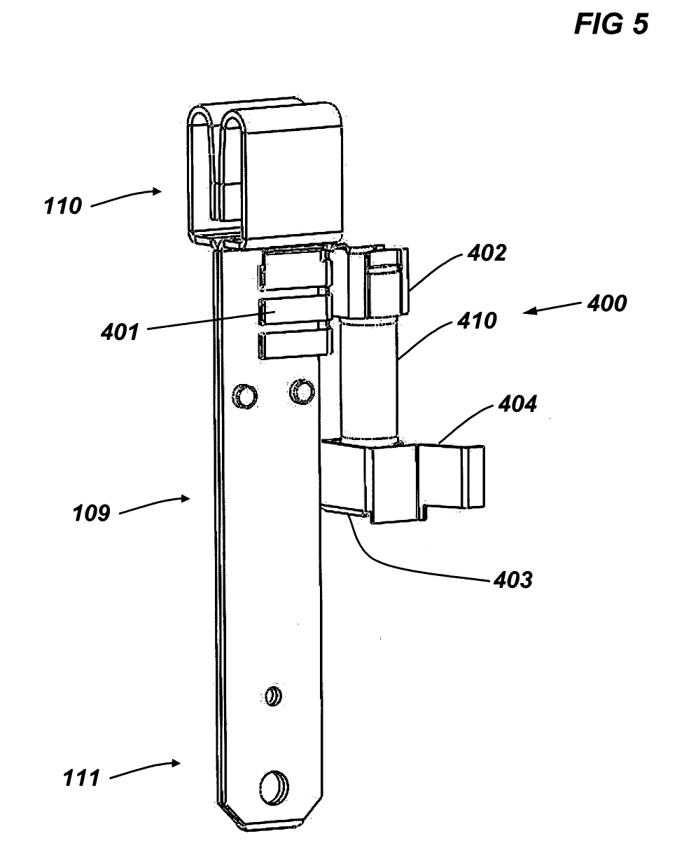

As shown in FIG. 5, attached to power pin 109 (for a line side terminal), is branch fuse holder 400 that fixedly holds fuse 410. Holder 400 has conductive friction grips 401 to attach (electrically and mechanically) holder 400 to power pin 109 associated with a line side terminal; first and second fuse holder brackets 402 and 403 that releasably hold fuse 410 by conventional snap spring mechanisms; and electric terminal 404 depending from second bracket 403 and intended for electric connection to a load circuit (being a branch load or circuit on the meter line side, not shown). Fuse 410 is in electrical parallel relationship with power pin 109 (for a line side terminal).

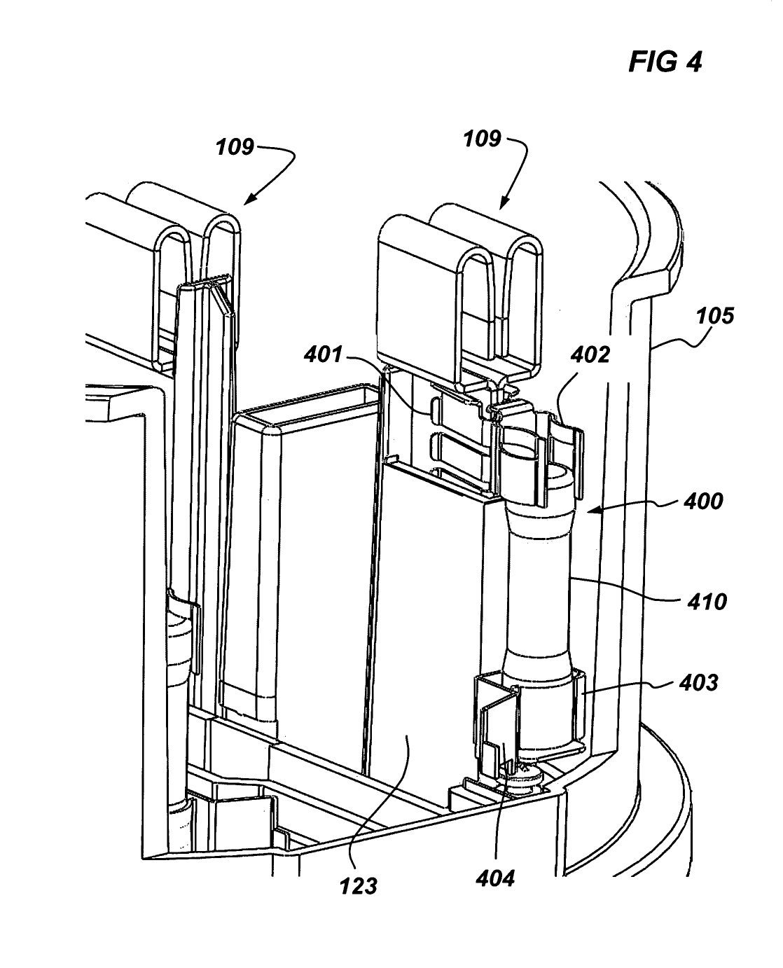

In FIG. 4, collar mounting slot 123 has been partially broken away to show branch fuse holder 400 and grips 401 partially inserted therein. The walls of slot 124 are profiled to receive grips 401 in a removably insertable relationship while providing a snug fit therewith.

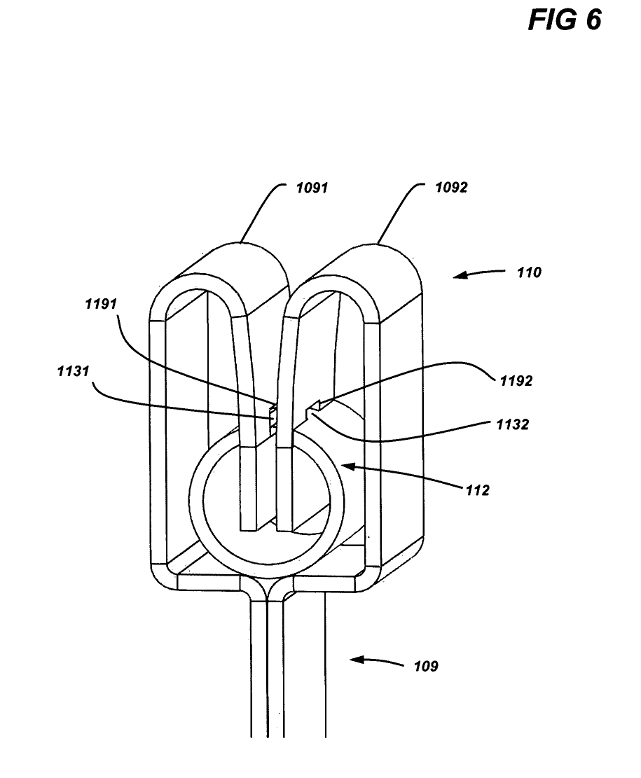

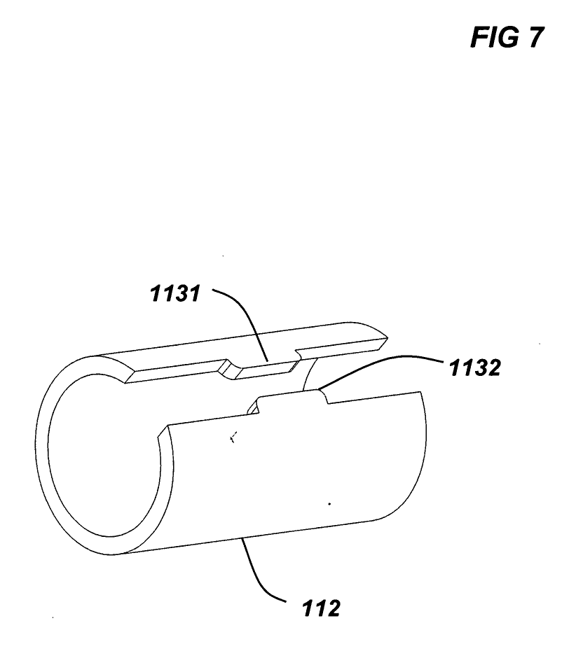

As shown in FIGS. 5-7, power pin 109 has jaw 110 and blade terminal 111. Jaw 110 includes two, opposed clips or fingers 1091 and 1092, and ring spring 112 to keep those fingers in opposition and resistant to their separation. Ring spring 112 is shown only in FIGS. 6-7 for simplicity of illustration in other drawings. Power pin fingers 1091 and 1092 are identical and are orientated in opposition as shown and are further described below.

Ring spring 112, as shown in FIGS. 6-7, has two opposed, identical protruding tabs 1131 and 1132. Jaw fingers 1091 and 1092 have respectively apertures 1141 and 1142 that respectively accepts insertion of ring spring tabs 1131 and 1132.

Once tabs 1131 and 1132 are inserted in their respective associated apertures 1141 and 1142, they remain there, and ring spring 112 then biases opposed fingers 1091 and 1092 toward each other to resist separation in the “installed state” of meter 10. (i.e. when meter 10, and in particular its meter blades 11, 12, 13 and 14, are inserted into collar 105, and in particular, its power pins 109).

In “installed state”, jaw 110 of each power pin 109 (and in particular, fingers 1091 and 1092 thereof) releasably or removably receives therebetween a meter power blade (one of blades 11, 12 associated with meter line side terminals, or one of blades 13 and 14 associated with meter load side terminals); and blade terminal 111 of each power pin 109 is inserted into the corresponding socket of meter socket 20; thereby creating electrical agency between meter 10 and meter socket 20. In “installed state”, ring spring 112 force fingers 1091 and 1092 towards each other to enhance the sandwich grip thereby on meter power blades 11, 12, 13 or 14.

When meter 10 is not inserted into collar 105 (the “uninstalled state”), although ring spring 112 contacts fingers 1091 and 1092 at tabs 1131 in apertures 1141 and 1142, they apply no or very little force on fingers 1091 and 1092.

Conventional jaws are completely planar or have a hard angle that becomes the edge of contact with the installed meter blade. In contrast, power pin jaw finger 1091 is smoothly curved. The curve is modeled on the behaviour of three locations thereof, 1091a, 1091b and 1091c, in response to the installation of meter 10 into collar 105 (i.e. the insertion of a meter blade into power pin jaw 110), as explained below.

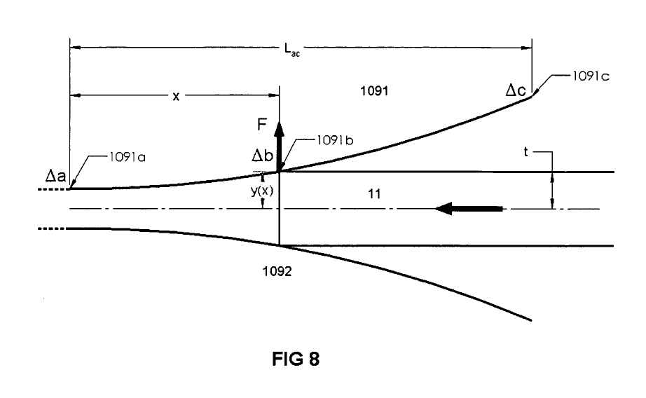

FIG. 8 shows (but not to scale) the approximate forces acting on a collar jaw as a meter blade is inserted therein. FIG. 8 has a frame of reference for a typical application (e.g. meter 10-collar 105-meter socket 20 combination is horizontally orientated relative to the vertical outside wall of a house), where meter blade 11 is inserted horizontally from the right, leftwardly into jaw 110, and thereby creating a vertically upward displacement of jaw finger 1091 (i.e. vertical separation between jaw fingers 1091 and 1092) because the resulting force F is vertically upwards. Because of the symmetries, only finger 1091 is shown and explained below (because the force diagram for opposed finger 1092 is identical to that of finger 1091 and merely orientated vertically downward instead).

As seen in FIG. 8, location 1091a is approximately where jaw finger 1091 begins to curve and where ring spring tab 1131 is in jaw finger aperture 1141 (as explained below), i.e. is about where ring spring 112 directly acts on jaw finger 1091. Edge 1091b is the edge of contact between the leading, terminal edge of meter blade 11 and jaw finger 1091. Crest 1091c is the location representing the effective end of the curve (for modeling purposes). The curvature of finger 1091 is set by requiring a force F (created by the insertion of meter blade 11 into jaw finger 1091) to be maximum and uniform across the contact surface, acting vertically on jaw finger 1091, as seen at these three locations of jaw finger 1091, i.e. “spring location” 1091a, “leading edge” 1091b and “jaw crest” 1091c. The vertical displacement of a point on the (jaw finger model) curve (represented by “x” on the horizontal axis being the axis of insertion of meter blade 11) is modelled by force factors and vertical displacements at these three locations. Such a force F creates advantageous (mechanical and electrical) interaction between meter 10 and collar 105.

First, the vertical displacement of “spring location” 1091a (employing a rigid beam model of jaw finger 1091), is approximated by:

Δa=(F·(Lac−x)/Lac)/Ka

where x=0 corresponds to spring location 1091a; Ka=approximated effect of the (inward) remainder of jaw at 1091a represented by a spring stiffness thereat; and Lac=horizontal distance between “spring location” 1091a and “jaw crest” 1091c.

Next, the vertical displacement of “jaw crest” position 1091c is due to the force felt at that position (assuming a rigid beam model), and is approximated as:

Δc=(F·x/Lac)/Kc where Kc=approximated effect of the (outward) remainder of jaw at 1091c represented by a spring stiffness thereat; E=modulus of elasticity of copper; and I=the area moment of the cross-section of the meter blade profile=w·t³/12, where w=width of meter blade and t=half of the thickness of the meter blade (as applicable to interaction with jaw finger 1091).

Due to these above factors, the total vertical displacement of “leading edge” position 1091b (employing a rigid beam model of jaw finger 1091), is approximated by:

Δb(rigid)=Δc·(x/Lac)+Δa·(L-x)/Lac

Next, employing an elastic beam model of jaw finger 1091 with fixed ends at 1091a and 1091c, the vertical displacement of “leading edge” 1091b is approximated as;

Δb(elastic)=(F·x²·(Lac-x)²)/(3·l·Lac)

Thus the total vertical displacement of “leading edge” 1091b at position (x) is

L(x)=Δb(rigid)+ΔAb(elastic).

Jaw finger 1091 is advantageously formed to have a curve in accordance with preceding formula. The preceding explanation applies identically to jaw finger 1092 and meter blades identical to meter blade 11.

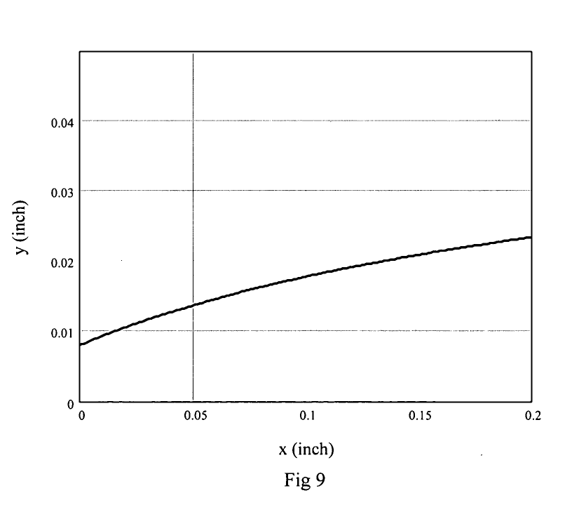

An example of the model formula is show in FIG. 9, wherein t=50 mil; w=755 mil; Ka=5 Lbf/mil; Kc=3 Lbf/mil.

In uninstalled state, the separation between fingers 1091 and 1092 is about 57 mils; and in installed state, the separation is in the order of 100 mils.

Examples of details of the practising of the present invention, include the following. Ring spring 112 metal is 302 or 301 stainless steel with minimum yield strength of 150000 psi. Fuse 410 is a common, high interrupt amperage capability. Power pin 109 is made of hard copper with tin plating. Fuse holder 400 is made of phosphor bronze and can be made integrally by suitable bending of a single sheet of such metal. Collar 105 may be formed of polycarbonate plastic or any other material having similar physical properties, such as those related to robustness, rigidity, temperature sensitivity, and electrical insulation. Ring spring 112 can be made of a single metal sheet of appropriate tensile and other properties, that can be cut and bent cylindrically to create opposed tabs 1131 and 1132 that are alignably insertable into corresponding apertures 1141 and 1142 of fingers 1091 and 1092 respectively.

Fingers 1091 and 1092 of power pin 109 are identical and are orientated in opposition as shown in the drawings. They may be made of a single sheet bent at the point corresponding to the jaw terminal 110 (to obviate the need of a fastener thereto). If fingers 1091 and 1092 are made discretely, they may be conventionally fastened rigidly (e.g. rivets).

Although a cylindrical ring spring 112 is disclosed, other generally C-shaped shapes are possible, each with respective advantages and disadvantages. For example, a V-shaped spring is possible.

The branch circuit may be within (entirely or partially) within collar 105 or connect to loads (i.e. devices) applicable in the factory, house or other venues. Examples of branch loads include those related to auxiliary power supply, data modem (for examples, for Internet Protocol based communications and Wide Area Networks and Local Area Networks (both wireless and wired embodiments), and external VOIP supervisory circuitry. Some branch loads may be manifested in compact form and be insertable (entirely or partially) within collar 105 and directly contact branch fuse terminal 404 (as shown). An example is the “adapter assembly” of U.S. Pat. No. 7,040,920, which may, for example, house an auxiliary backup battery pack.

But also, some branch loads may be physically remote from collar 105 but electrically connected to branch fuse terminals 404.

Although branch fuse holder 400 has been shown and explained for a line side power pin, it can be used for a load line power pin, with fuse 410 appropriate for the applicable branch circuit load.

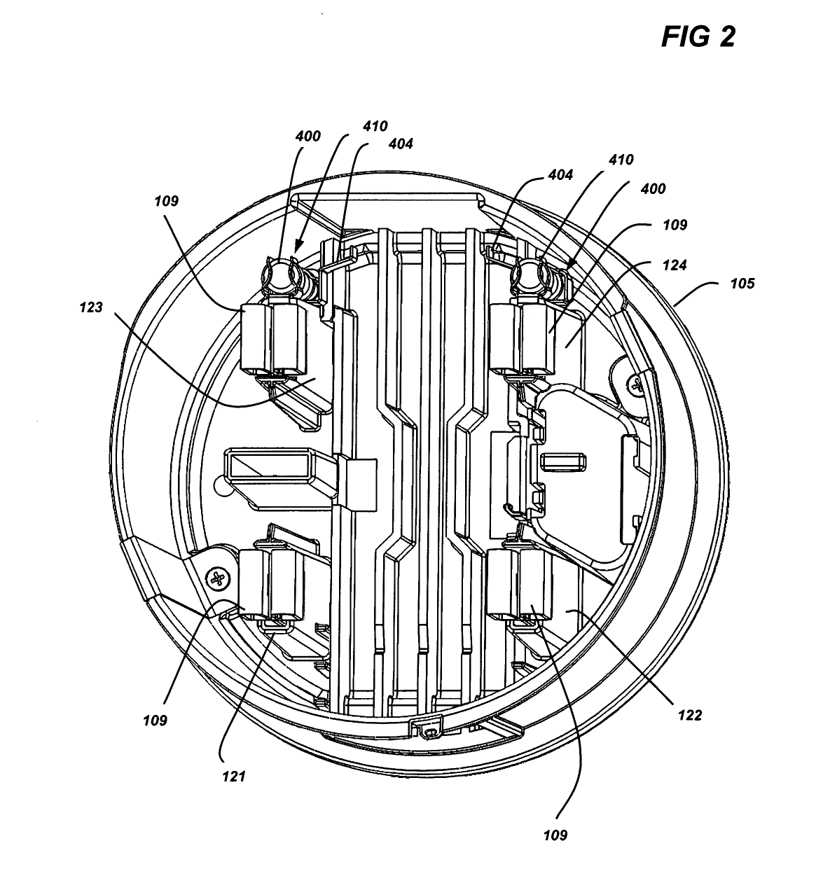

Also, although two branch fuse holders 400 have been shown, one will suffice for some applications and this invention does not require two. However, depending on the particular application and risk management concerns, the advantages of redundancy of two branch fuses are justified—in addition to redundancy, fuse 410 for both line side terminals (as shown in FIG. 2) will protect against electric faults in the power line occurring on both sides of meter 10.

Although fuse holder 400 has been shown with conductive friction grips 401 to attach (electrically and mechanically) holder 400 to power pin 109, other fuse holders and conductive attachments are contemplated as physically residing within collar 105, in particular, and electrically on the load line side of meter 10, more generally.

Although the embodiment described relates to a standard electrical power meter conforming to Form 2S, this invention is applicable to other standard meters (such as Form 3S and 4S) where only obvious modifications are necessary to accommodate a different socket/power pin arrangement. Also, it is understood by those in the art that this ANSI standard is unlikely to be modified substantially in the future but if it is modified slightly, it will be readily apparent to those in the art that this invention may be easily adjusted accordingly to fit the amended envelope or form factor. It would be a matter of simple design to accommodate different form factors (i.e. geometry of and number of sockets) and different types of meters (e.g. single-phase or multi-phase).

Although the method and apparatus of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims. All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

1. A collar adapter for a utility meter and its associated meter socket, which has terminals for the line side and terminals for the load side, comprising:
(a) a first power pin for receiving first terminal blade of the meter;
(b) said first power pin is connectable to first line side terminal of the meter socket;
(c) a first branch fuse, attached to said line side power pin, that is in electrical parallel relationship thereto and that runs to a branch load circuit.

2. A collar adapter for a utility meter and its associated meter socket, which has terminals for the line side and terminals for the load side, comprising:
(a) a power pin for receiving one terminal blade of the meter; and
(b) said power pin having a jaw that is curved according to the formula: etc.

3. A collar adapter for a utility meter and its associated meter socket, which has terminals for the line side and terminals for the load side, comprising:
(a) a power pin that has two opposed jaws for receiving one terminal blade of the meter; and
(b) a C-shaped ring spring that biases said jaws towards each other.

4. The collar of claim 1, further comprising:
(a) second power pin for receiving second terminal blade of the meter;
(b) said second power pin is connectable to second line side terminal of the meter socket;
(c) second branch fuse, attached to said second line side power pin, that is in electrical parallel relationship thereto and that runs to said branch load circuit.
